(19) United States
(12) Patent Application Publication
(10) Pub. No.: US 2016/0302892 A1
(43) Pub. Date: Oct. 20, 2016

(54) SUPRAOSSEOUS DENTAL IMPLANT

(71) Applicant: MOHAMMAD ALMOGAHWI, NEW YORK, NY (US)

(72) Inventor: MOHAMMAD ALMOGAHWI, NEW YORK, NY (US)

(21) Appl. No.: 14/690,714

(22) Filed: Apr. 20, 2015

(51) Int. Cl. A61C 8/00

(52) U.S. Cl. CPC A61C 8/0031; A61C 8/0022; A61C 8/0013

(57) ABSTRACT

The supraosseous dental implant is formed from a framework made of osseointegration material, such as titanium or the like, and which is configured to lie atop a patient's alveolar bone such that an inner surface of the framework is supported at least partially by the patient's alveolar bone. A plurality of abutments are secured to an outer surface of the framework and project coronally therefrom for attachment of a plurality of crowns. The framework is implanted by first anesthetizing the soft tissue covering the alveolar bone and opening a flap in the gums above the alveolar ridge. The framework is placed on the alveolar bone and fixed thereto using titanium screws or the like. The flap is closed, and following healing of the soft tissue and at least partial osseointegration of the framework with the alveolar bone, the crowns are secured to their respective abutments.

### BACKGROUND OF THE INVENTION

1. Field of the Invention

The present invention relates generally to dental restorations for fully and partially edentate patients, and particularly to a supraosseous dental implant for the repair of partial or complete edentulism, and a surgical method of implantation and use of the supraosseous dental implant.

2. Description of the Related Art

Edentulism is the condition of being toothless to at least some degree. In organisms (such as humans) that naturally have dentition, it is the result of tooth loss. Loss of some teeth results in “partial edentulism”, whereas loss of all teeth results in “complete edentulism”. Persons who have lost teeth are either partially or completely “edentulous” or “edentate”. Edentulism is commonly treated or repaired with dental implants (also known as endosseous implants or fixtures), which are surgical components that interface with the bone of the jaw or skull to support a dental prosthesis, such as a crown, bridge, denture, or facial prosthesis, or which act as an orthodontic anchor. The basis for modern dental implants is a biologic process called osseointegration, where materials, such as titanium, form an intimate bond to bone. The implant fixture is first placed so that it is likely to osseointegrate, and then a dental prosthetic is added. A variable amount of healing time is required for osseointegration before either the final dental prosthetic (a tooth, bridge or denture) is attached to the implant, or a final abutment is placed that will hold a dental prosthetic.

For an implant to osseointegrate, it needs to be surrounded by a healthy quantity of bone. In order for it to survive long term, it needs to have a healthy soft tissue (gingiva) envelope around it. It is common for either the bone or soft tissue to be so deficient that the surgeon needs to reconstruct it, either before or during implant placement. However, when there is bone loss, particularly in the alveolar bone (also known as the “alveolar process”), a bone graft is typically performed. The most common type of bone graft is guided bone graft augmentation, where a defect is filled with either natural (harvested or autograft) bone or allograft (donor bone or synthetic bone substitute), covered with a semi-permeable membrane, and allowed to heal. During the healing phase, natural bone replaces the graft, forming a new bony base for the implant. The bone graft, though, is a complicated surgical procedure, requiring a great deal of time for preparation, the procedure itself, and healing, which is often painful.

With the conventional vertical procedure of endosseous implantation, there are numerous risks involved, including the normal risks of surgery, such as infection, excessive bleeding and necrosis of the flap of tissue around the implant. Nearby anatomic structures, such as the inferior alveolar nerve, the maxillary sinus and blood vessels, can also be injured when the osteotomy is created or the implant is placed. Further, an inability to place the implant in bone to provide stability of the implant (referred to as “primary stability” of the implant) increases the risk of failure of osseointegration. Additionally, post-implantation, long-term failures may occur, due to either loss of bone around the tooth and/or gingiva due to peri-implantitis or a mechanical failure of the implant.

Thus, a supraosseous dental implant solving the aforementioned problems is desired.

### SUMMARY OF THE INVENTION

The supraosseous dental implant is formed from a framework that is made of osseointegration material, such as titanium or the like, and which is configured to lie atop a patient's alveolar ridge such that an inner surface of the framework is at least partially supported by the patient's maxilla or mandible. A plurality of abutments are secured to an outer surface of the framework and project coronally therefrom for attachment of a plurality of crowns or other dental restorations thereto.

In use, the patient's alveolar bone is first scanned using a computer tomography (CT) scan or the like, and a three-dimensional cast of the patient's alveolar bone is printed or otherwise formed from the scan. Alternatively, a conventional impression of the patient's alveolar bone may be taken to form the cast. The framework, in the form of a rim surrounding a wire grid or mesh, is then formed on the cast of the alveolar bone. The framework, as noted above, is formed from material allowing the framework to osseointegrate with the alveolar bone. As additional alternatives, the inner surface may be further treated via texturing or coating with assisting materials to further enhance osseointegration. The outer surface of the framework may also alternatively be textured by laser micro-groove formation or the like to form a surface that more efficiently attaches to the soft tissue of the patient. The abutments are secured to the framework and may be coated with a layer of zirconia or the like to facilitate attachment of the soft tissue thereto, and further to provide aesthetic enhancement to the prosthesis.

The implant is placed in the patient's mouth by first anesthetizing the soft tissue covering the alveolar bone, and a flap is surgically opened therein. The framework is checked for a proper fit before final implantation. The alveolar bone may first be decorticated, or treated by any suitable procedure to initiate osseointegration, and then the framework is placed on top of the alveolar bone (either the maxilla or the mandible) and fixed thereto using titanium screws or the like. The flap is then surgically closed and the soft tissue is left to heal. During the healing process, a temporary prosthesis may be used. Following healing of the soft tissue and osseointegration of the framework with the alveolar bone, the crowns or other dental restoration(s) (e.g., a bridge or partial denture) are secured to their respective abutments.

These and other features of the present invention will become readily apparent upon further review of the following specification and drawings.

### BRIEF DESCRIPTION OF THE DRAWINGS

FIG. 1 is a top view of a supraosseous dental implant according to the present invention.

FIG. 2 is an environmental side view in section of the supraosseous dental implant according to the present invention.

Similar reference characters denote corresponding features consistently throughout the attached drawings.

### DETAILED DESCRIPTION OF THE PREFERRED EMBODIMENTS

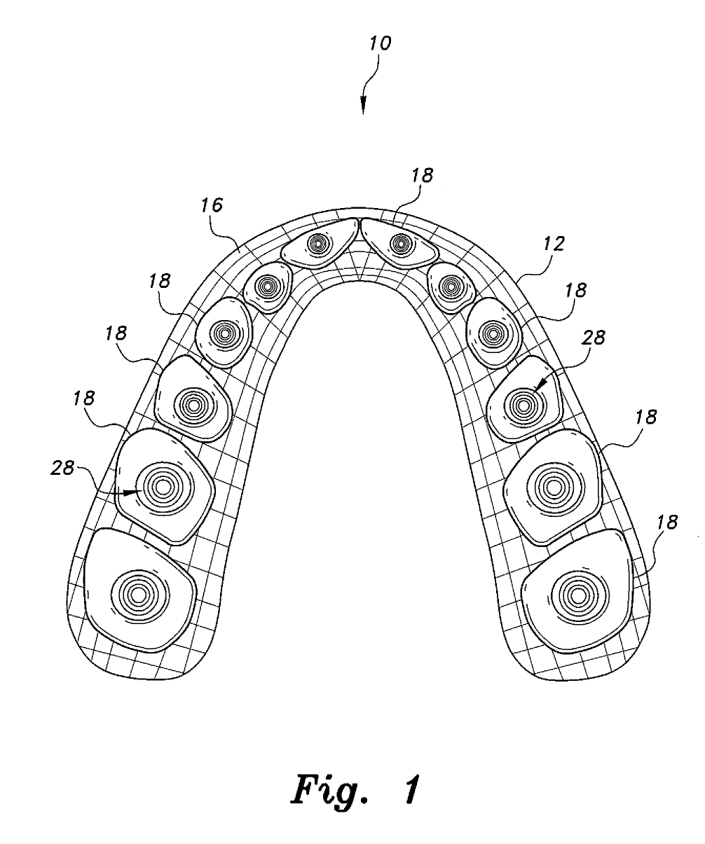

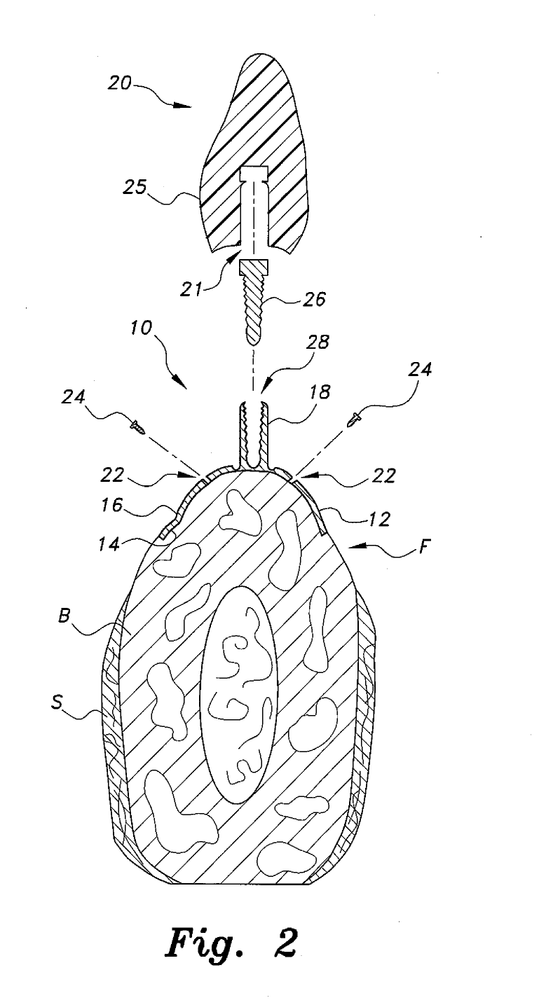

As shown in FIGS. 1 and 2, the supraosseous dental implant 10 is formed from a framework 12 that is made of osseointegration material (i.e., a material which is readily ossoeintegrated), such as titanium or the like, and which is configured to lie atop a patient's alveolar ridge B (as shown in FIG. 2), such that an inner surface 14 of the framework 12 is at least partially supported by the patient's maxilla or mandible. A plurality of abutments 18 are secured to an outer surface 16 of the framework 12 and project coronally for attachment of a plurality of crowns 20 or other dental restorations.

In use, the patient's alveolar ridge B is first scanned using a computer tomography (CT) scan or the like, and a three-dimensional cast of the patient's alveolar bone is printed or otherwise formed from the scan. Alternatively, a conventional impression of the patient's alveolar bone may be taken to form the cast. The framework 12, in the form of a rim surrounding a wire grid or mesh formed from titanium or other suitable osseointegration materials, is then formed on the cast of the alveolar bone. It should be understood that the material forming the framework 12 is suitable for osseointegration, while the pores defined by the wire grid or mesh promote soft tissue healing. However, it should be understood that the framework 12 shown in the Figures is shown for illustrative and exemplary purposes only, and may, for example, alternatively comprise a plate having a plurality of pores or the like defined therein, or may be configured as any other suitable type of framework conventionally known in the art of supraosseous dental implants for promotion of healing, but formed from titanium or other suitable osseointegration materials. As additional alternatives, the inner surface 14 of framework 12 may be further treated via texturing or coating with assisting materials to further enhance osseointegration with the alveolar bone B. Similarly, the outer surface 16 of the framework 12 may be textured or treated to form a surface that more efficiently attaches to the soft tissue S of the patient. Texturing may be performed by any suitable method, such as, for example, by laser micro-groove formation or the like.

The abutments 18 are secured to the upper surface 16 of the framework 12 and may be coated with a layer of zirconia or the like to facilitate attachment of the soft tissue S thereto, and to further enhance the aesthetics of the prosthesis. It should be understood that abutments 18 may be formed integrally as one piece with the framework 12, or may be manufactured as separate components and secured thereto via any suitable type of process or fixture.

The prosthesis 10 is implanted by first anesthetizing the soft tissue S covering the alveolar ridge B and a flap or flap F is surgically opened in the soft tissue S. The framework 12 is checked for a proper fit before final implantation. The alveolar bone may first be decorticated (or treated by any suitable procedure to initiate osseointegration), and then the framework 12 is placed on the alveolar bone and fixed thereto. In FIG. 2, titanium screws 24 are shown engaging with openings 22 formed through framework 12, for fixing the framework 12 to the alveolar bone. It should be understood that the framework 12 may be fixed by any suitable method.

The flap F is then surgically closed and the soft tissue S is left to heal. Following healing of the soft tissue and osseointegration of the framework with the alveolar bone, the crowns 20 are secured to their respective abutments 18. A temporary prosthesis may be used during the healing period. In FIG. 2, each crown 20 is shown having an exterior tooth portion 25 and defining a central recess 21 for receiving a screw 26, as in a conventional dental crown, such that the screw 26 may be screwed into a threaded recess 28 of a respective abutment 18. It should be understood that crowns 20 may be secured to abutments 18 by any suitable method, such as cementing or the like, and that screws 26 and the corresponding threaded recesses 28 are shown for exemplary purposes only.

The nature of the titanium material and the microgrooves or other texturing formed in the surface of the framework enhance osseointegration of the supraosseous dental implant 10 to the alveolar bone of the maxilla or the mandible, as well as aiding soft tissue healing, respectively.

It is to be understood that the present invention is not limited to the embodiments described above, but encompasses any and all embodiments within the scope of the following claims.

1. A supraosseous dental implant, comprising:
a porous framework formed from osseointegration material and configured to lie atop a patient's alveolar bone, the porous framework consisting of a wire grid, wherein the outer surface of the framework is treated to promote healing of soft tissue of the patient, the framework having an inner surface at least partially supported by the patient's alveolar bone, wherein the inner surface is textured for osseointegration with the patient's alveolar bone;
a plurality of abutments formed integrally with and projecting coronally from the framework and being spaced about the framework, wherein each of the abutments has a threaded recess defined therein; and
a plurality of screws securing the framework to the alveolar bone.

2. The supraosseous dental implant as recited in claim 1, wherein the osseointegration material comprises titanium.

3-5. (canceled)

6. The supraosseous dental implant as recited in claim 1, wherein each said abutment is coated with a layer of zirconia.

7. A dental restoration, comprising a supraosseous dental implant as recited in claim 1 having a crown attached to said at least one abutment.

8. The supraosseous dental implant as recited in claim 7, wherein said crown defines an inner recess for receiving a screw.

9. The supraosseous dental implant as recited in claim 8, wherein said at least one abutment has a threaded recess defined therein, the screw being fastened into the threaded recess to secure said crown to the implant.

10-13. (canceled)

14. A surgical method for repairing edentulism, comprising the steps of:
preparing a framework formed from titanium and configured to lie atop a patient's alveolar bone, the framework having at least one abutment secured thereto and projecting coronally, the framework having an inner surface textured for osseointegration with the patient's alveolar bone;
opening a flap in the patient's gums above the alveolar ridge;
placing the framework under the flap on the patient's alveolar bone;
fixing the framework to the patient's alveolar bone;
closing the flap;
allowing sufficient time for the patient's gingival tissues to heal and for at least partial osseointegration of the framework with the patient's alveolar bone; and
then attaching a dental restoration to the at least one abutment.

15. The surgical method for repairing edentulism as recited in claim 14, further comprising the step of decorticating the patient's alveolar bone prior to placing the framework thereon.

16. The surgical method for repairing edentulism as recited in claim 16, further comprising the steps of:
scanning the patient's alveolar ridge using a computer tomography (CT) scan; and
forming a three-dimensional cast of the patient's alveolar bone from the scan, the framework being prepared from the cast.

17. The surgical method for repairing edentulism as recited in claim 16, further comprising the steps of:
making an impression of the patient's alveolar ridge; and
forming a three-dimensional cast of the patient's alveolar bone from the impression, the framework being prepared from the cast.
